(19) United States
(12) Patent Application Publication
(10) Pub. No.: US 2008/0266453 A1
(43) Pub. Date: Oct. 30, 2008

(54) Automatic Determination of Local Time for Terrestrial Broadcast Digital Television Receiver

(75) Inventor: Jeffrey P. Fisher, Dublin, CA (US)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 11/739,714

(22) Filed: Apr. 25, 2007

(51) Int. Cl. H04N 9/475

(52) U.S. Cl. 348/516; 348/E09.029

(57) ABSTRACT

A method by which a DTV receiver that receives a terrestrial broadcast DTV signal may automatically determine the local time for the local terrestrial broadcast region, as well as DTV receivers that implements such a method, is described. The method includes obtaining a unique identifier of a terrestrial broadcast signal, wherein the unique identifier is transmitted as part of the terrestrial broadcast signal, accessing a memory to obtain a local time offset and a Daylight Savings Time (DST) observance indicator associated with the unique identifier, and calculating the local time based on the local time offset and the DST observance indicator. Additional methods for providing channel availability information to a user based on the unique identifier are described.

### BACKGROUND OF THE INVENTION

1. Field of the Invention

The invention generally relates to digital television. More specifically, the invention is related to systems and devices that receive terrestrial (over-the-air) broadcast of digital television signals.

2. Background

The Advanced Television Systems Committee (ATSC) digital television standard defines standards for digital television broadcasting. The ATSC standard has been adopted by the United States, Canada, Mexico, South Korea, and recently Honduras and is also being considered by other countries. In the United States, the ATSC standard is intended to replace the National Television Standards Committee (NTSC) standard for analog television broadcasting, with all NTSC analog broadcasts currently scheduled to end by Feb. 17, 2009.

ATSC document A/65C, entitled “Program and System Information Protocol for Terrestrial Broadcast and Cable (Revision C) with Amendment No. 1” (hereinafter referred to as “the PSIP document”), defines tables that must be included in all ATSC-compliant transport streams to be transmitted via terrestrial broadcast or cable. One such table is denoted the System Time Table (STT). As set forth in Section 6.1 of the PSIP document, the STT includes a system time field (“system_time”) and a Global Positioning System (GPS) Coordinated Universal Time (UTC) offset field (“GPS_UTC_offset”). The system time is a 32-bit unsigned integer quantity representing the current system time as the number of GPS seconds since 00:00:00 UTC, Jan. 6, 1980. The GPS UTC offset is an 8-bit unsigned integer that defines the current offset in whole seconds between GPS and UTC time standards. To convert from GPS to UTC time, the GPS UTC offset is subtracted from the system time. Thus, by using the system time and GPS UTC offset fields provided as part of the STT, a digital television (DTV) receiver can determine the current UTC.

Unfortunately, however, the PSIP document does not include a provision for a DTV receiver to obtain the local time offset and/or Daylight Savings Time (DST) observance for a local terrestrial broadcast region. Such information is necessary in order to determine the local time. As stated in Annex A of the PSIP document: “In order to convert GPS into local time, the receiver needs to store a time offset (from GPS to local time) in local memory and an indicator as to whether daylight savings is observed. These two quantities can be obtained from the user interface (indicating time zone and daylight savings observance) or from the conditional access system, if present, and stored in non-volatile receiver memory.” In other words, where the DTV signal is provided in conjunction with a conditional access system, as is in certain cable or satellite systems, the local time offset and DST observance can be provisioned by the access provider. However, where the DTV signal is received via terrestrial broadcast, the only way to obtain the local time offset and DST observance is for the user to enter the information via a user interface, such as a graphical user interface displayed to the user via the television screen.

The ability to determine the local time is necessary in order to correctly display the local time to the user, to provide the user with information about programs that are currently airing, or to provide the user with a valid schedule of programs to be aired in the future. However, it is burdensome to require a user to provide the local time offset and DST observance when setting up their television or DTV receiver. While users of personal computers (PCs) may be accustomed to performing such steps when first setting up their PCs, many consumers may find entering such information confusing or annoying. This may be particularly true for users of older analog televisions. These users will be forced to use a government-subsidized analog-to-digital conversion box to receive DTV signals when analog broadcasts are turned off in February of 2009.

Furthermore, in a case where the user is required to provide the local time offset and DST observance, there is a possibility that the user will provide the wrong information thereby resulting in incorrect program scheduling information being displayed to the user. In such an instance, the user will need to detect the error, determine its cause, and then re-access the user interface by which such information is provided to enter the correct information.

From the manufacturer's standpoint, the requirement of providing a user interface by which the user can select the local time offset and set the DST observance indicator increases the cost and complexity of the DTV receiver that includes such functionality.

What is needed, then, is a technique that allows a DTV receiver that receives a terrestrial broadcast DTV signal to automatically determine the local time for the local terrestrial broadcast region. To this end, the desired technique should allow the DTV receiver to automatically obtain the local time offset and DST observance for the local terrestrial broadcast region. The desired technique should not require any action by or input from the television user or require the use of any proprietary communication protocol between a DTV transmitter and the DTV receiver.

### BRIEF SUMMARY OF THE INVENTION

The present invention provides a technique by which a DTV receiver that receives a terrestrial broadcast digital television signal can automatically determine the local time for the local terrestrial broadcast region. In accordance with an embodiment of the present invention, the DTV receiver automatically determines the local time in a manner that does not require any action by or input from the television user or the use of any proprietary communication protocol between a DTV transmitter and the DTV receiver.

In particular, an embodiment of the present invention is a method for automatically determining a local time in a DTV receiver. In accordance with the method, a unique identifier of a terrestrial broadcast signal is obtained, wherein the unique identifier is transmitted as part of the terrestrial broadcast signal. A memory is accessed to obtain a local time offset and a DST observance indicator associated with the unique identifier. The local time is then calculated based on the local time offset and the DST observance indicator.

The unique identifier of the terrestrial broadcast signal may be a Transport Stream ID obtained from a Terrestrial Virtual Channel Table or from a Program Association Table associated with the terrestrial broadcast signal or a Transmission Signal ID obtained from an EIA/CEA-608-B data stream embedded within the terrestrial broadcast signal. Calculating the local time may include obtaining a Coordinated Universal Time (UTC), adding the local time offset to the UTC and then adding an additional value to the sum of the local time offset and the UTC dependent upon the state of the DST observance indicator.

Once the local time has been calculated, information may be provided to user based at least in part on the local time. This information may include one or more of the local time, information about a program currently being aired, or information about a program to be aired in the future.

Another embodiment of the present invention is a DTV receiver. The DTV receiver includes a memory and logic. The logic is adapted to obtain a unique identifier of a terrestrial broadcast signal received by the DTV receiver, wherein the unique identifier was transmitted as part of the terrestrial broadcast signal. The logic is further adapted to access the memory to obtain a local time offset and a DST observance indicator associated with the unique identifier and to calculate the local time based on the local time offset and the DST observance indicator.

The unique identifier of the terrestrial broadcast signal may be a Transport Stream ID obtained from a Terrestrial Virtual Channel Table or from Program Association Table transmitted as part of the terrestrial broadcast signal or a Transmission Signal ID from an EIA/CEA-608-B data stream embedded within the terrestrial broadcast signal. The logic may be further adapted to obtain a Coordinated Universal Time (UTC) and to calculate the local time by adding the local time offset to the UTC and then adding an additional value to the sum of the local time offset and the UTC dependent upon the state of the DST observance indicator.

The logic may be still further adapted to provide information to a user based at least in part on the local time. Such information may include one or more of the local time, information about a program currently being aired, or information about a program to be aired in the future

Yet another embodiment of the present invention is a method for providing channel availability information from a DTV receiver to a user. In accordance with the method, a unique identifier of a terrestrial broadcast signal received by the DTV receiver is obtained, wherein the unique identifier is transmitted as part of the terrestrial broadcast signal. A memory is then accessed to identify broadcast channels that the DTV receiver should be capable of receiving based on the unique identifier. A notification is then provided to the user concerning which of the identified broadcast channels the DTV receiver should be capable of receiving but is not.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example digital television (DTV) broadcasting system in which an embodiment of the present invention may operate.

FIG. 2 is a block diagram of an example DTV receiver that implements the present invention.

FIG. 3 illustrates a logical structure of a database that maps a TSID (Transport Stream Identifier or Transmission Stream Identifier) to a local time offset and Daylight Savings Time (DST) observance indicator in accordance with an embodiment of the present invention.

FIG. 4 depicts a flowchart of a method for automatically determining local time for a terrestrial broadcast DTV receiver in accordance with an embodiment of the present invention.

FIG. 5 depicts a flowchart of a method for providing channel availability information from a DTV receiver to a user in accordance with an embodiment of the present invention.

FIG. 6 illustrates a DTV receiver that includes a channel availability database in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Example Operating Environment

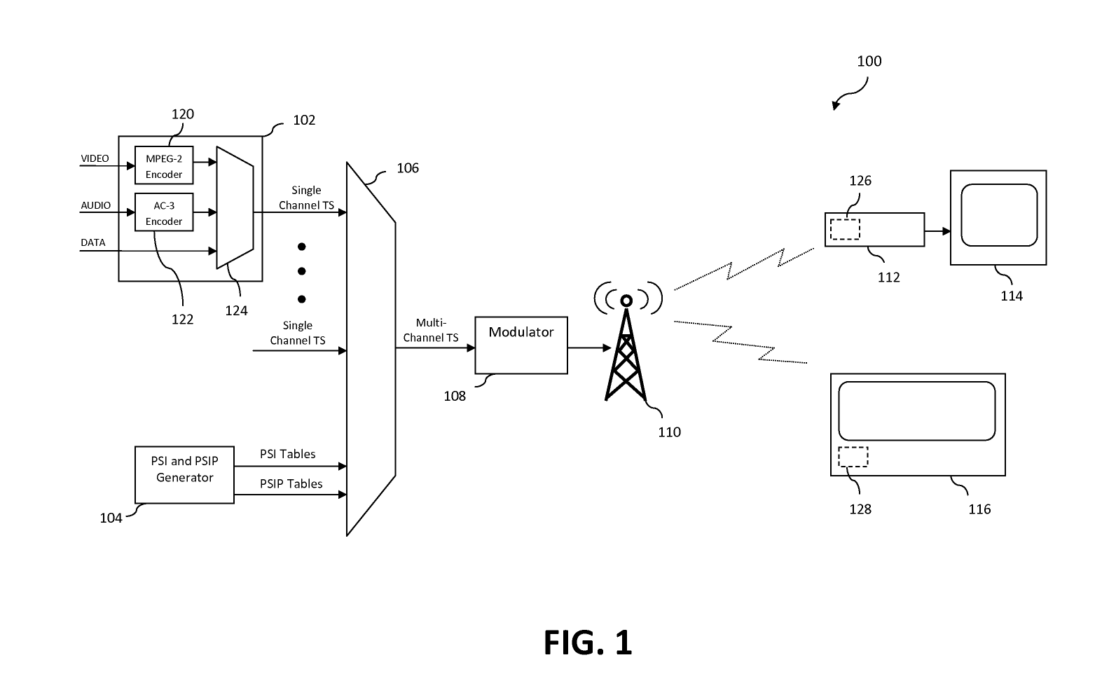

FIG. 1 illustrates an operating environment in which an embodiment of the present invention may operate. In particular, FIG. 1 shows a digital television (DTV) broadcasting system 100 in which an ATSC-compliant television signal is broadcast from a DTV transmitter 110 and is received by a first DTV receiver 126 and a second DTV receiver 128. Persons skilled in the relevant art(s) will readily appreciate that a DTV broadcasting system may include more than one DTV transmitter. Persons skilled in the relevant art(s) will also readily appreciate that a DTV broadcasting system would likely include many more than two DTV receivers in a given broadcast area. Nevertheless, only single DTV transmitter 110 and two DTV receivers 126 and 128 are shown in FIG. 1 for the sake of simplifying the description of DTV broadcasting system 100.

The ATSC-compliant television signal broadcast by DTV transmitter 110 carries multiple digital (or virtual) channels within a single radio frequency (RF) channel. This is achieved by multiplexing multiple single program transport streams into a multi-channel transport stream. In particular, as shown in FIG. 1, a program encoder 102 encodes video data associated with a first program using an MPEG-2 encoder 120, encodes audio data associated with the first program using an AC-3 encoder 122, and multiplexes the encoded video data, the encoded audio data, and auxiliary data associated with the first program using a first multiplexer 124 to generate a first single program transport stream. Additional single program transport streams corresponding to different programs are generated in a like manner using additional program encoders (not shown in FIG. 1).

The single program transport streams are combined by a second multiplexer 106 to generate a multi-program transport stream. As shown in FIG. 1, also inserted into the multi-program transport stream are Program Specific Information (PSI) and Program and System Information Protocol (PSIP) information, which are provided by a PSI and PSIP generator 104.

The PSI information is data that identifies what part of the multi-program transport stream belongs to a particular program. Transmission of the PSI information is required for conformance with the MPEG-2 standard. Since the ATSC standard requires MPEG-2 conformance, insertion of the PSI information is necessary in order for the signal broadcast by transmitter 110 to be ATSC-compliant. At a minimum, the PSI information includes a Program Association Table (PAT) and a Program Map Table (PMT). The PAT is the entry point for the PSI tables. For each assigned program number, the PAT lists the packet id (PID) for packets containing that program's PMT. The PMT lists all the PIDs for packets containing elements of a particular program (audio, video, auxiliary data, and Program Clock Reference (PCR)). The syntax for each table is defined within International Standard ISO/IEC 13818-1. According to the ATSC standards, the PAT must be transmitted at least once every 100 milliseconds (ms) and the PMT must be transmitted once every 400 ms.

The PSIP information includes information about the transmitting station and the programs that are being broadcast. The PSIP information is used by a DTV receiver to identify a DTV station and to determine how to tune to it. The PSIP information may identify both a DTV channel and an associated analog channel. In addition to identifying a channel number, the PSIP information indicates whether multiple program channels are being broadcast and, if so, how to find them. Among other things, it identifies whether the programs are closed-captioned, if data is associated with the program, and also conveys V-chip information. Properly-encoded PSIP data in DTV signals is vital information for receivers to correctly identify and tune to a particular station.

For terrestrial broadcasts, the PSIP information includes a number of tables, including a Terrestrial Virtual Channel Table (TVCT), a Master Guide Table (MGT), a System Time Table (STT), Event Information Tables (EIT), and may include a Rating Region Table (RRT). The TVCT defines, at a minimum, the MPEG-2 programs embedded in the transport stream in which the TVCT is carried. The MGT defines the type, PIDs, and versions for all the other PSIP tables in the transport stream, except for the STT. The STT defines the current date and time of day. The EITs describe hours of events (TV programs) and include all of the virtual channels listed in the TVCT. The RRT defines the TV parental guideline (rating information) system referenced by any content advisory descriptor carried within the transport stream, except for RRTs corresponding to certain areas.

Further information concerning the PSIP information, including the maximum cycle times for transmission of the PSIP tables, may be found in ATSC document A/65C, entitled “Program and System Information Protocol for Terrestrial Broadcast and Cable (Revision C) with Amendment No. 1,” the entirety of which is incorporated by reference herein.

With continued reference to FIG. 1, the multi-program transport stream output from second multiplexer 106 is received by a modulator 108, which converts the multi-program transport stream into a form suitable for broadcast. Modulator 108 may be, for example, an 8-vestigital sideband (VSB) modulator. DTV transmitter 110 receives the signal from modulator 108 and transmits it on an assigned frequency.

As shown in FIG. 1, the ATSC-compliant broadcast signal is received by first DTV receiver 126 and second DTV receiver 128. As will be described in more detail herein, each DTV receiver converts the broadcast signal from an analog to digital form, demodulates the converted signal, de-multiplexes the transport streams and PSI/PSIP information embedded within the demodulated signal, and decodes a selected transport stream for display to a user on a television.

First DTV receiver 126 is shown as an integrated part of a device 112 attached to a television 114. Device 112 may comprise a set-top box, digital video recorder (DVR), video cassette recorder (VCR), or other device adapted for outputting video and/or audio data to a television. In one embodiment, device 112 is a digital-to-analog converter box that operates to convert the ATSC-compliant broadcast signal into a format suitable for display on an NTSC-compliant television. In contrast to first DTV receiver 126, second DTV receiver 128 is shown as an integrated part of a television 116. Thus, television 116 may be considered “DTV-ready.”

Although DTV receivers 126 and 128 are shown as being integrated within a television or within a device connected to a television, persons skilled in the art will readily appreciate that DTV receivers may also be included in other types of devices as well, such as handheld media devices or audio devices. Thus, the example operating environment depicted in FIG. 1 is not intended to limit the present invention.

### B. Example DTV Receiver in Accordance with an Embodiment of the Present Invention

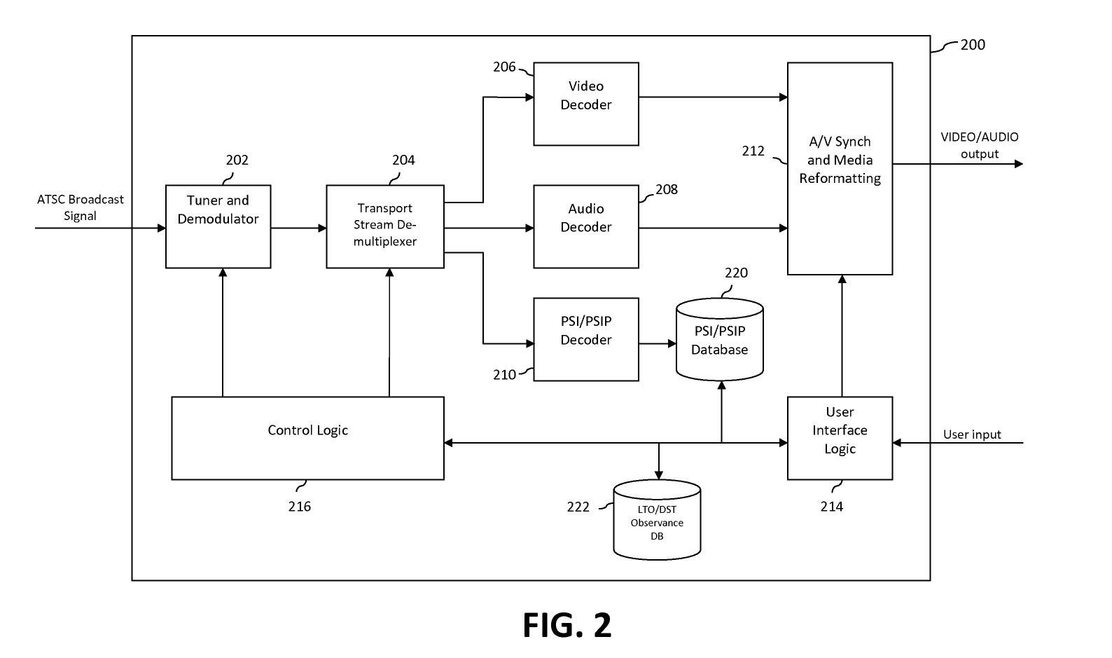

FIG. 2 illustrates an example DTV receiver 200 that implements the present invention. DTV receiver 200 is described herein by way of example only and is not intended to limit the present invention. Persons skilled in the relevant art(s) will readily appreciate that the present invention may be implemented in other types of DTV receivers, or in other devices or systems entirely.

Example DTV receiver 200 includes a number of processing blocks that are described herein in terms of the signals that they receive and transmit as well as in terms of their function. It is to be understood that each of these processing blocks may be implemented in hardware using analog and/or digital circuits, in software, through the execution of instructions by one or more general purpose or special-purpose processors, or as a combination of hardware and software. In one embodiment, DTV receiver 200 is implemented as an application-specific integrated circuit (ASIC) that includes circuit blocks for performing certain functions in hardware, as well as a microprocessor subsystem block for performing other functions in software. Communication between the various processing blocks is by way of one or more busses internal to the ASIC. However, this implementation is described by way of example only and is not intended to limit the present invention.

As shown in FIG. 2, example DTV receiver 200 includes a tuner and demodulator 202. The tuner portion of tuner and demodulator 202 receives the ATSC broadcast signal from an antenna and converts it from an analog signal to a digital signal. Tuning is performed under the control of control logic 216. The demodulator portion of tuner and demodulator 202 demodulates the digital signal. In one embodiment, the demodulator portion of tuner and demodulator 202 is an 8-VSB demodulator.

Transport stream de-multiplexer 204 is connected to tuner and demodulator 202 and receives a demodulated signal therefrom. Transport stream de-multiplexer 204 selectively extracts single program transport streams from the demodulated signal as well as PSI/PSIP information embedded within the demodulated signal. Transport stream de-multiplexer 204 extracts this information under the control of control logic 216.

Once transport stream de-multiplexer 204 has selected a single program transport stream within the demodulated signal, it provides an MPEG-2 encoded video stream associated with the selected program to video decoder 206, which decodes the video signal and outputs the decoded video signal to audio/visual (A/V) synchronization and media reformatting block 212. Transport stream de-multiplexer 204 also provides an AC-3 encoded audio stream associated with the selected program to audio decoder 208, which decodes the audio signal and outputs the decoded audio signal to A/V synchronization and media reformatting block 212.

A/V synchronization and media reformatting block 212 performs functions to synchronize the video and audio content and to convert the content into a format suitable for display by a television or other media playing device or system. In one embodiment, A/V synchronization and media reformatting block 212 performs functions necessary to convert the video content into a format suitable for display by a digital television. In an alternate embodiment, A/V synchronization and media reformatting block 212 performs functions necessary to convert the video content into a format suitable for display by an analog television.

As noted above, transport stream de-multiplexer 204 extracts PSI and PSIP information from the demodulated signal provided by ATSC tuner and demodulator 202. This PSI and PSIP information is output to a PSI/PSIP decoder 210, which parses the information and stores it as PSI and PSIP tables in a PSI/PSIP database 220. These tables are then accessible to control logic 216 and user interface logic 214. Control logic 216 uses information from the PSI and PSIP tables to control the tuner within tuner and demodulator 202 to receive broadcast signals from a particular DTV station. Control logic 216 also uses information from the tables to control transport stream de-multiplexer 204 to select a particular program for decoding and display.

In the embodiment shown in FIG. 2, PSI/PSIP database 220 is located in a memory internal to DTV receiver 200. This memory preferably comprises a read-write memory, such as any type of random access memory (RAM). In an alternate embodiment, PSI/PSIP database 220 is stored in a memory device that is external to DTV receiver 200 and connected thereto via an appropriate interface.

As shown in FIG. 2, DTV receiver 200 further includes user interface logic 214. Among other functions, user interface logic 214 receives input signals originating from a user that indicate which channel the user wishes to tune to and which programs the user wishes to watch and passes such information to control logic 216. User interface logic also uses information stored in PSI/PSIP database 220 to generate information to be displayed to the user via the television screen. Such information may include the local time, the channel the user is watching, the broadcast entity associated with the channel, the name of a program that is currently airing or other information about the program, or a schedule of programs to be aired in the future (i.e., a program guide). Because such information is displayed on the television screen, it is provided to A/V synch and media reformatting block 212 where it replaces or is combined with the current video output signal.

In order to display the local time, information concerning programs that are currently airing, or a schedule of programs to be aired in the future, user interface logic 214 must first obtain the local time for the local terrestrial broadcast region. To do this, user interface logic 214 must obtain a local time offset and Daylight Savings Time (DST) observance indicator for the local terrestrial broadcast region. However, as noted in the Background section of the present application, this information is not provided in the PSIP information carried by the ATSC-compliant broadcast signal, nor is this information carried in any other standardized way within the broadcast signal.

In accordance with an embodiment of the present invention, user interface logic 214 automatically derives the local time offset and DST observance for the local terrestrial broadcast region in a manner that does not require a user to input information to the DTV receiver and that does not require the use of a proprietary protocol for passing such information from the DTV transmitter to the DTV receiver. In one embodiment of the present invention, to be discussed in more detail below, user interface logic 214 accomplishes this by obtaining a Transport Stream Identifier (TSID) from a Terrestrial Virtual Channel Table (TVCT) stored in PSI/PSIP database 220. The user interface logic 214 then accesses a local time offset (LTO)/DST observance database 222 that maps TSIDs to local time offsets and DST observance indicators. Using the TSID, user interface logic 214 is thus able to obtain the appropriate local time offset and DST observance indicator from LTO/DST observance database 222. Using the obtained information, along with the Coordinated Universal Time (UTC) (which is derived from information in the System Time Table (STT) stored in PSI/PSIP database 220, as will be discussed in more detail below), user interface logic 214 is then able to determine the local time for the local terrestrial broadcast region.

As noted above, LTO/DST observance database 222 maps TSIDs to local time offsets and DST observance indicators. The TSID is a unique 16-bit identifier that the FCC assigns to the terrestrial broadcaster. Because each terrestrial broadcaster is located in a fixed geographic location, it is possible to determine the local time offset and DST observance that applies to each terrestrial broadcaster. Since there is a one-to-one relationship between each TSID and each terrestrial broadcaster (i.e., each TSID uniquely identifies a terrestrial broadcaster), it is further possible to create a database, such as LTO/DST observance database 222, that maps TSIDs to local time offsets and DST observance indicators.

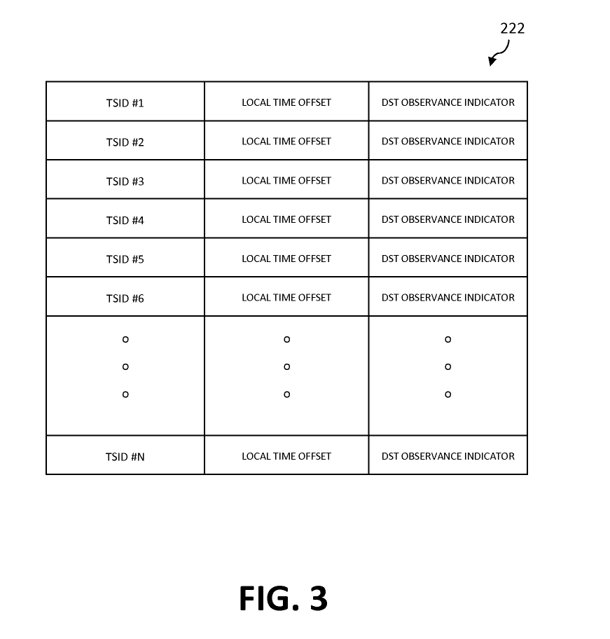

An example of a logical structure of LTO/DST observance database 222 is shown in FIG. 3. As shown in FIG. 3, the database includes a series of unique TSIDs (TSID # 1 through TSID # N). Associated with each TSID in LTO/DST observance database 222 is a local time offset and a DST observance indicator. The local time offset and DST observance indicators are not unique fields. In other words, different TSIDs may have the same local time offset value and/or DST observance indicator. In an embodiment, the local time offset is a signed integer value and the DST observance indicator is a 1-bit flag, with a “1” indicating that DST is in effect and a “0” indicating that DST is not in effect. However, these examples are not intended to limit the present invention, and other formats and values may be used to denote the local time offset and DST observance.

In an alternate embodiment of the present invention, in addition to maintaining a local time offset and DST observance indicator for each TSID as shown in FIG. 3, LTO/DST observance database 222 also maintains a DST local time offset, which represents what the local time offset should be when taking into account DST observance.

In an embodiment of the present invention, LTO/DST observance database 222 comprises a look-up table that is indexed by the unique TSID value associated with a local terrestrial broadcaster. Thus, the TSID can be directly mapped to the local time offset and DST observance indicator associated with the TSID. However, any of a wide number of known data structures and/or database types may be used to associate a TSID with a local time offset and DST observance indicator in accordance with the present invention and the invention is not limited to the use of a look-up table.

As shown in FIG. 2, LTO/DST observance database 222 is stored in a memory that is internal to DTV receiver 200. Because it is not anticipated that the TSID to local time offset/DTS observance mappings will change frequently over time, LTO/DST observance database 222 is preferably provisioned into a non-volatile memory within DTV receiver 200 prior to making DTV receiver 200 available to a consumer. By storing these mappings in a non-volatile memory, there is no need to re-load the information into memory every time DTV receiver 200 is powered on. The non-volatile memory may be, for example, an electrically erasable programmable read only memory (EEPROM) or a flash memory, although these examples are not intended to be limiting. Because EEPROMs and flash memories are re-programmable, the use of such technology makes it possible to update LTO/DST observance database 222 even after DTV receiver 200 has been distributed to a consumer. However, as noted above, the mappings change infrequently and thus this may not be necessary.

In alternate embodiments of the present invention, LTO/DST observance database 222 is stored in other types of memory within DTV receiver 200, including but not limited to any type of RAM or ROM. In still alternate embodiments of the present invention, LTO/DST observance database 222 is stored in a memory device that is external to DTV receiver 200 and connected thereto via an appropriate interface.

### C. Example Method for Automatically Determining Local Time in Accordance with an Embodiment of the Present Invention

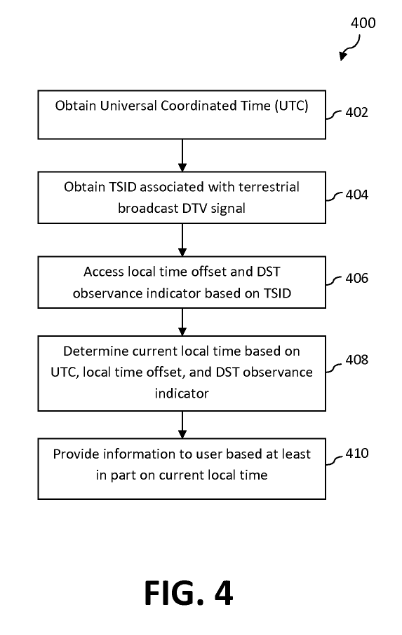

FIG. 4 depicts a flowchart 400 of a method for automatically determining local time for a terrestrial broadcast DTV receiver in accordance with an embodiment of the present invention. The method of flowchart 400 will be described with continued reference to DTV receiver 200 of FIG. 2, although the invention is not limited to that embodiment. Additionally, although the steps of flowchart 400 are described as being performed by user interface logic 214 of DTV receiver 200, these steps may also be performed by control logic 216, or by a combination of user interface logic 214 and control logic 216.

The method of flowchart 400 begins at step 402, in which user interface logic 214 of DTV receiver 200 obtains the Coordinated Universal Time (UTC), which is also known as Greenwich Mean Time (GMT). This is achieved by accessing a system time field (“system_time”) and a Global Positioning System (GPS) UTC offset field (“GPS_UTC_offset”) within the PSIP System Time Table (STT) stored in PSI/PSIP database 220. The system time is a 32-bit unsigned integer quantity representing the current system time as the number of GPS seconds since 00:00:00 UTC, Jan. 6, 1980. The GPS UTC offset is an 8-bit unsigned integer that defines the current offset in whole seconds between GPS and UTC time standards. Since, unlike UTC, GPS time is not perturbed by leap seconds it is ahead of UTC by the GPS UTC offset amount. To determine the UTC, user interface logic 214 subtracts the GPS UTC offset from the system time.

At step 404, user interface logic 214 obtains a TSID associated with a received terrestrial broadcast DTV signal. In one embodiment, this is achieved by obtaining a TSID from a Terrestrial Virtual Channel Table (TVCT) stored in PSI/PSIP database 220. As noted above, the TSID is uniquely associated with a local terrestrial DTV broadcaster. In a case in which PSI/PSIP database stores multiple TVCTs associated with multiple respective local broadcasters, user interface logic 214 may obtain the TSID associated with the last channel to which DTV receiver 200 was tuned. Alternatively, some other method may be used to select among the multiple TSIDs.

In an alternate embodiment, user interface logic 214 obtains a TSID associated with a received terrestrial broadcast DTV signal by obtaining a TSID from a Program Association Table (PAT) stored in PSI/PSIP database 220.

At step 406, user interface logic accesses LTO/DST observance database 222 and obtains a local time offset and DST observance indicator using the TSID obtained in step 404. As noted above, the TSID may be used as an index to a look-up table that stores local time offsets and DST observance indicators. However, alternative methods for linking a TSID to local time offsets and DST observance indicators may be used.

At step 408, user interface logic 214 calculates the local time based on the UTC obtained in step 402 and on the local time offset and DST observance indicator obtained in step 406. This is achieved by adding the local time offset to the UTC and then adding an additional integer value depending on the state of the DST observance indicator. In an embodiment of the present invention, this additional integer value is provided by user interface logic 214. In an alternate embodiment, this additional integer value is stored along with the DST observance indicator in LTO/DST observance database 222.

In a still further embodiment of the present invention, if the DST observance indicator is positive (i.e., DST is in effect), then the local time is calculated by adding a DST local time offset that is obtained from LTO/DST observance database 222 to the UTC instead of adding the regular local time offset to the UTC.

At step 410, once the local time has been determined, user interface logic 214 then uses it to provide information to a user via the television screen, wherein such information is based at least in part on the local time. Such information may include but is not limited to the local time, information concerning one or more program(s) that are currently airing, or a schedule of programs to be aired in the future.

### D. Alternative Methods for Obtaining a TSID in Accordance with Embodiments of the Present Invention

As noted above, in one embodiment of the present invention, a Transport Stream ID (TSID) that uniquely identifies a terrestrial broadcaster is obtained from the PSIP TVCT (or from the PSI TAP) stored within PSI/PSIP database 220. However, in alternate embodiments of the present invention, an analog Transmission Signal ID (the acronym is also TSID) that also uniquely identifies the terrestrial broadcaster may be obtained from the ATSC-compliant broadcast signal. In particular, this analog TSID may be obtained from an EIA/CEA-608-B data stream embedded within an ATSC MPEG-2 video elementary transport stream. EIA/CEA-608-B is an industry standard published by the Electronics Industry Alliance for using or providing Closed Captioning services or other data services embedded in line 21 of the Vertical Blanking Interval of an NTSC video signal. This standard is incorporated by reference in its entirety herein.

The analog TSID may be obtained instead of, or in addition to, the TSID obtained from the PSI/PSIP database 220. For example, if user interface logic 214 is unable to obtain a valid TSID from PSI/PSIP database 220, it may attempt to obtain the analog TSID from the EIA/CEA-608-B data stream. Alternatively, user interface logic 214 may first attempt to obtain a valid analog TSID from the EIA/CEA-608-B data stream and, if it cannot do so, then obtain the TSID from the PSI/PSIP database 220. In a further alternate embodiment, even if a valid TSID is obtained from PSI/PSIP database 220, user interface logic 214 may use the analog TSID obtained from the EIA/CEA-608-B data stream to verify that the TSID obtained from PSI/PSIP database 220 is valid, or vice versa.

### E. Alternative Use of TSID Information to Improve DTV Receiver Performance

The foregoing described the use of a TSID (obtained from PSI/PSIP database 220 and/or from an EIA/CEA-608-B data stream) to identify a local time offset and DST observance for calculating the local time in a local terrestrial broadcast region. In accordance with an alternate embodiment of the present invention described below, the TSID may also be used to obtain other information that may be used to improve the performance of a DTV receiver. This alternate embodiment will now be described.

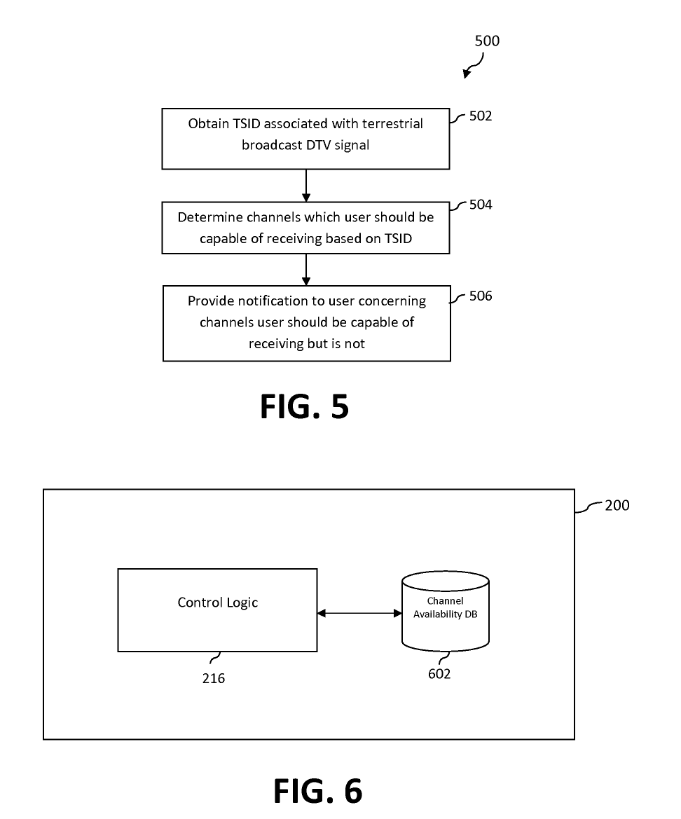

FIG. 5 depicts a flowchart 500 of a method for providing channel availability information from a DTV receiver to a user in accordance with an embodiment of the present invention. The method of flowchart 500 will be described in part with continued reference to DTV receiver 200 of FIG. 2, although the invention is not limited to that embodiment.

The method of flowchart 500 begins at step 502 in which control logic 216 obtains a TSID associated with a received terrestrial broadcast DTV signal. In one embodiment, this step includes obtaining a TSID from a TVCT or PAT stored in PSI/PSIP database 220. In an alternate embodiment, this step alternatively or additionally includes obtaining an analog TSID from an EIA/CEA-608-B data stream embedded within an ATSC MPEG-2 video elementary transport stream.

At step 504, control logic 214 accesses a database that associates a TSID with broadcast channels that should be available to DTV receivers located in the same terrestrial broadcast region as the terrestrial broadcaster identified by the TSID. FIG. 6 illustrates an embodiment in which such a database, denoted channel availability database 602, is provisioned within DTV receiver 200 for access by control logic 214. Channel availability database 602 may be implemented in memory internal to DTV receiver 200 in a like manner to LTO/DST observance database 222 as described above. In an alternative embodiment, channel availability database 602 is stored in a memory device that is external to DTV receiver 200 and connected thereto via an appropriate interface.

Since each terrestrial broadcaster is located in a fixed geographic location, it is possible to infer from the TSID where the terrestrial broadcaster (and the DTV receiver for that matter) is located and therefore identify other broadcast channels that should exist in the local area but might not be received by the DTV receiver due to poor signal quality. Since there is a one-to-one relationship between each TSID and each terrestrial broadcaster (i.e., each TSID uniquely identifies a terrestrial broadcaster), it is possible to create a database, such as database 602, that maps TSIDs to broadcast channels that should be available to the DTV receiver.

At step 506, control logic 214 determines which of the available channels identified in step 504 are currently not being received by DTV receiver 200. Control logic 214 then provides this information to user interface logic 216, which provides a notification to a user concerning the missing channel(s). This information can help the user determine if a new antenna is needed to receive the channels or indicate to the user a direction in which to point their antenna to improve the chances of receiving the missing channel(s).

### F. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for automatically determining a local time in a digital television (DTV) receiver, comprising:
obtaining a unique identifier of a terrestrial broadcast signal, wherein the unique identifier is transmitted as part of the terrestrial broadcast signal;
accessing a memory to obtain a local time offset and a Daylight Savings Time (DST) observance indicator associated with the unique identifier; and
calculating the local time based on the local time offset and the DST observance indicator.

2. The method of claim 1, wherein obtaining a unique identifier of a terrestrial broadcast signal comprises obtaining a Transport Stream ID associated with the terrestrial broadcast signal.

3. The method of claim 2, wherein obtaining a Transport Stream ID associated with the terrestrial broadcast signal comprises obtaining a Transport Stream ID from a Terrestrial Virtual Channel Table associated with the terrestrial broadcast signal.

4. The method of claim 2, wherein obtaining a Transport Stream ID associated with the terrestrial broadcast signal comprises obtaining a Transport Stream ID from a Program Association Table associated with the terrestrial broadcast signal.

5. The method of claim 1, wherein obtaining a unique identifier of a terrestrial broadcast signal comprises obtaining a Transmission Signal ID associated with the terrestrial broadcast signal.

6. The method of claim 5, wherein obtaining a Transmission Signal ID associated with the terrestrial broadcast signal comprises obtaining a Transmission Signal ID from an EIA/CEA-608-B data stream embedded within the terrestrial broadcast signal.

7. The method of claim 1, wherein accessing a memory to obtain a local time offset and a DST observance indicator associated with the unique identifier comprises accessing a lookup table using the unique indicator as an index.

8. The method of claim 1, further comprising:
obtaining a Coordinated Universal Time (UTC);
wherein calculating the local time based on the local time offset and the DST observance indicator comprises adding the local time offset to the UTC and then adding an additional value to the sum of the local time offset and the UTC dependent upon the state of the DST observance indicator.

9. The method of claim 1, further comprising:
providing information to a user based at least in part on the local time.

10. The method of claim 8, wherein providing information to a user comprises providing to the user at least one of: the local time, information about a program currently being aired, or information about a program to be aired in the future.

11. A digital television (DTV) receiver, comprising:
a memory; and
logic adapted to obtain a unique identifier of a terrestrial broadcast signal received by the DTV receiver, wherein the unique identifier was transmitted as part of the terrestrial broadcast signal, to access the memory to obtain a local time offset and a Daylight Savings Time (DST) observance indicator associated with the unique identifier, and to calculate the local time based on the local time offset and the DST observance indicator.

12. The DTV receiver of claim 11, wherein the logic is adapted to obtain a Transport Stream ID of the terrestrial broadcast signal.

13. The DTV receiver of claim 12, wherein the logic is adapted to obtain the Transport Stream ID from a Terrestrial Virtual Channel Table transmitted as part of the terrestrial broadcast signal.

14. The DTV receiver of claim 12, wherein the logic is adapted to obtain the Transport Stream ID from a Program Association Table transmitted as part of the terrestrial broadcast signal.

15. The DTV receiver of claim 11, wherein the logic is adapted to obtain a Transmission Signal ID associated with the terrestrial broadcast signal.

16. The DTV receiver of claim 15, wherein the logic is adapted to obtain the Transmission Signal ID from an EIA/CEA-608-B data stream embedded within the terrestrial broadcast signal.

17. The DTV receiver of claim 11, wherein the logic is adapted to access the memory using the unique indicator as an index.

18. The DTV receiver of claim 11, wherein the logic is further adapted to obtain a Coordinated Universal Time (UTC) and to calculate the local time by adding the local time offset to the UTC and then adding an additional value to the sum of the local time offset and the UTC dependent upon the state of the DST observance indicator.

19. The DTV receiver of claim 11, wherein the logic is further adapted to:
provide information to a user based at least in part on the local time.

20. The DTV receiver of claim 19, wherein the logic is adapted to provide to the user at least one of: the local time, information about a program currently being aired, or information about a program to be aired in the future

21. A method for providing channel availability information from a DTV receiver to a user, comprising:
obtaining a unique identifier of a terrestrial broadcast signal received by the DTV receiver, wherein the unique identifier is transmitted as part of the terrestrial broadcast signal;
accessing a memory to identify broadcast channels that the DTV receiver should be capable of receiving based on the unique identifier; and
providing a notification to the user concerning which of the identified broadcast channels the DTV receiver should be capable of receiving but is not.
